(19) United States
(12) Patent Application Publication
(10) Pub. No.: US 2009/0051671 A1
(43) Pub. Date: Feb. 26, 2009

(54) RECOGNIZING THE MOTION OF TWO OR MORE TOUCHES ON A TOUCH-SENSING SURFACE

(76) Inventor: Jason Antony Konstas, Tokyo (JP)

Correspondence Address: CYPRESS/BLAKELY;Blakely Sokoloff Taylor & Zafman LLP, 1279 Oakmead Parkway, SUNNYVALE, CA, 94085-4040, US

(21) Appl. No.: 12/195,989

(22) Filed: Aug. 21, 2008

Related U.S. Application Data
(60) Provisional application No. 60/957,248, filed on Aug. 22, 2007.

(51) Int. Cl. G06F 3/045; G06F 3/041

(52) U.S. Cl. 345/174; 345/173

(57) ABSTRACT

An apparatus and method for recognizing the motion of multiple touches on a touch-sensing surface. In one embodiment, the touch-sensing surface is divided into multiple logical zones. Each of the logical zones has a configurable granularity. The apparatus and method detects multiple substantially simultaneous touches on the surface, and tracks the motions of the touches across the logical zones to identify a multi-touch gesture.

### RELATED APPLICATION

This application claims the benefit of U.S. Provisional Application No. 60/957,248, filed on Aug. 22, 2007.

### TECHNICAL FIELD

This disclosure relates to the field of user interface devices and, in particular, to gesture recognition on devices that have a touch-sensing surface.

### BACKGROUND

Computing devices, such as notebook computers, personal data assistants (PDAs), kiosks, and mobile handsets, have user interface devices, which are also known as human interface devices (HID). One user interface device that has become more common is a touch-sensor pad (also commonly referred to as a touchpad). A basic notebook computer touch-sensor pad emulates the function of a personal computer (PC) mouse. A touch-sensor pad is typically embedded into a PC notebook for built-in portability. A touch-sensor pad replicates mouse X/Y movement by using two defined axes which contain a collection of sensor elements that detect the position of a conductive object, such as a finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a pointer, or selecting an item on a display. These touch-sensor pads may include multi-dimensional sensor arrays for detecting movement in multiple axes. The sensor array may include a one-dimensional sensor array, detecting movement in one axis. The sensor array may also be two dimensional, detecting movements in two axes.

Another user interface device that has become more common is a touch screen. Touch screens, also known as touchscreens, touch panels, or touchscreen panels are display overlays which are typically either pressure-sensitive (resistive), electrically-sensitive (capacitive), acoustically-sensitive (surface acoustic wave (SAW)) or photo-sensitive (infra-red). The effect of such overlays allows a display to be used as an input device, removing the keyboard and/or the mouse as the primary input device for interacting with the display's content. Such displays can be attached to computers or, as terminals, to networks. There are a number of types of touch screen technologies, such as optical imaging, resistive, surface acoustical wave, capacitive, infrared, dispersive signal, piezoelectric, and strain gauge technologies. Touch screens have become familiar in retail settings, on point-of-sale systems, on ATMs, on mobile handsets, on kiosks, on game consoles, and on PDAs where a stylus is sometimes used to manipulate the graphical user interface (GUI) and to enter data. A user can touch a touch screen or a touch-sensor pad to manipulate data. For example, a user can apply a single touch, by using a finger to press the surface of a touch screen, to select an item from a menu.

### BRIEF DESCRIPTION OF THE DRAWINGS

The present disclosure is illustrated by way of example, and not by way of limitation, in the figures of the accompanying drawings.

FIG. 1 illustrates a block diagram of one embodiment of an electronic system having a processing device for recognizing a multi-touch gesture.

FIG. 2 illustrates a flow diagram of one embodiment of a method for recognizing a multi-touch gesture.

FIG. 3 illustrates an example of detecting two fingers on a XY matrix touch-sensing surface.

FIG. 4 illustrates an example of two definitions for the same gesture supporting left-handed and right-handed users.

FIG. 5 illustrates an example of two gestures with similar zone transitions.

FIG. 6 illustrates an example of aliasing a transition state of a complex gesture with a simpler gesture.

FIG. 7 illustrates an example of a symmetrical gesture.

FIG. 8 illustrates an example of linear control gestures and the corresponding recognition rules.

FIG. 9 illustrates an example of pan left/right gestures and the corresponding recognition rules.

FIG. 10 illustrates an example of rotate left gestures and the corresponding recognition rules.

FIG. 11 illustrates an example of rotate right gestures and the corresponding recognition rules.

FIG. 12 illustrates an example of pan up gestures and the corresponding recognition rules.

FIG. 13 illustrates an example of pan down gestures and the corresponding recognition rules.

FIG. 14 illustrates an example of grow (zoom in) gestures and the corresponding recognition rules.

FIG. 15 illustrates an example of shrink (zoom out) gestures and the corresponding recognition rules.

FIG. 16 illustrates an example of a 3-finger gesture and the corresponding recognition rules.

### DETAILED DESCRIPTION

Described herein is an apparatus and method for recognizing the motion of multiple touches on a touch-sensing surface. In one embodiment, the touch-sensing surface is divided into multiple logical zones. Each of the logical zones has a configurable granularity. The apparatus and method detects multiple substantially simultaneous touches on the surface, and tracks the motions of the touches across the logical zones to identify a multi-touch gesture.

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in a simple block diagram format in order to avoid unnecessarily obscuring the present invention. Thus, the specific details set forth are merely exemplary. Particular implementations may vary from these exemplary details and still be contemplated to be within the spirit and scope of the present invention.

A touch-sensing surface (e.g., a touch-sensor pad, a touchscreen, etc.) can be designed to detect the presence of multiple touches. A known technique for multi-touch detection uses a two-layer implementation: one layer to support rows and the other columns. Additional axes, implemented on the surface using additional layers, can allow resolution of additional simultaneous touches, but these additional layers come at a cost both in terms of materials and yield loss. Likewise, the added rows/columns/diagonals used in multi-axial scanning may also take additional time to scan, and more complex computation to resolve the touch locations.

Another known technique for multi-touch detection and gesture recognition requires the user to insert a time delay between the first and subsequent touches on the touch-sensing surface. This method imposes a restriction on the user's input method, and may be unreliable if the inserted time delay is small and approximately the same as the finger-touch sampling rate of the touch-sensing surface.

Embodiments of the present invention enable the development of a simple, reliable, easy-to-use multi-touch user interface through a touch-sensing surface that is constructed with rows and columns of self-capacitance sensors. Gesture recognition is achieved by correlating the detected motions with a set of pre-defined rules. These rules can be customized by human interface designers for a particular application in view of given dimensions of the touch-sensing surface and conductive objects (e.g., fingers). Human interface designers are able to define their own rules for a sequence of touch combinations and subsequent motions that constitute desired gestures. Rules can be defined to support left-handers, right-handers, single-hand or dual-hand operations. Further, the gesture recognition is supported by a standard 2-layer XY matrix touchscreens (where sensor elements are disposed as rows and columns) and split-screen 2-layer XY touchscreens (where the sensor elements along at least one dimension of the screen are grouped into different sections and each section can be separately scanned).

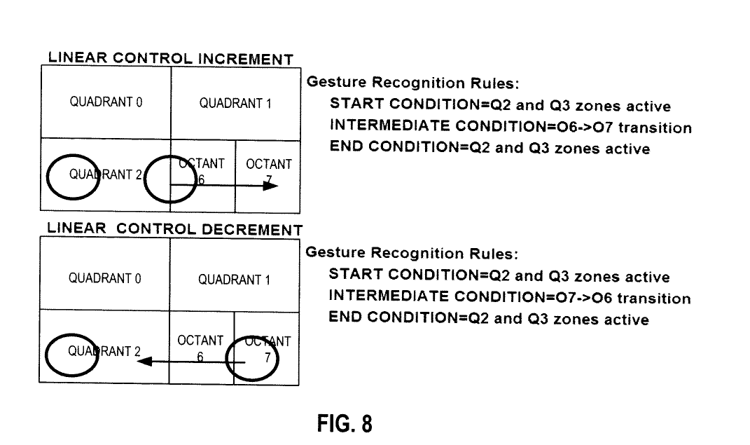

Embodiments of the present invention allow both the detection and motion tracking of multiple, substantially simultaneous finger touches on a 2-layer XY touch-sensing surface. A set of rules, which are defined for specific motions, are correlated with the detected motions to identify a gesture. Once a gesture is identified, corresponding operations (e.g., zoom in/out, rotate right/left, etc.) can be performed. According to embodiments of the present invention, the detection and motion tracking do not rely on physical divisions of the touch-sensing surface, but, instead, rely on the logical segmentation of the touch-sensing surface. The touch-sensing surface is segmented into multiple logical zones. The logical zones may be implemented as equal-sized halves of the surface, providing support for very simple gestures such as movements from left to right or up to down. As the complexity of the gesture increases, these zones may become physically smaller such as quadrants, octants, etc., with the upper limit in the number of zones dictated by the number of physical row and column sensors implemented on the touch-sensing surface construction. A combination of zones having different sizes may be concurrently used to provide the appropriate granularity for motion detection. For example, while a simple gesture that requires large finger movement relative to the touchscreen size may be detected using logical quadrants, a complex gesture with more limited finger motion can be detected using a combination of quadrants and octants. Some examples of gesture recognition are shown in FIGS. 8-16. A state machine may be used to detect the change in concurrently activated zones from one capacity-sensing scan interval to the next.

In one embodiment, the touch-sensing surface is a matrix capacitive-sensing surface that detects the change in capacitance of each element of a sensor array. The capacitance changes as a function of the proximity of a conductive object to the sensor element. The conductive object can be, for example, a stylus or a user's finger. On a touch-sensing surface, a change in capacitance detected by each sensor in the X and Y dimensions of the sensor array due to the proximity or movement of a conductive object can be measured by a variety of methods. Regardless of the method, usually an electrical signal representative of the capacitance detected by each capacitive sensor is processed by a processing device, which in turn produces electrical or optical signals representative of the position of the conductive object in relation to the touch-sensing surface in the X and Y dimensions.

However, it should also be noted that the embodiments described herein may be implemented in sensing technologies other than capacitive sensing, such as resistive, optical imaging, surface acoustical wave (SAW), infrared, dispersive signal, strain gauge technologies, or the like.

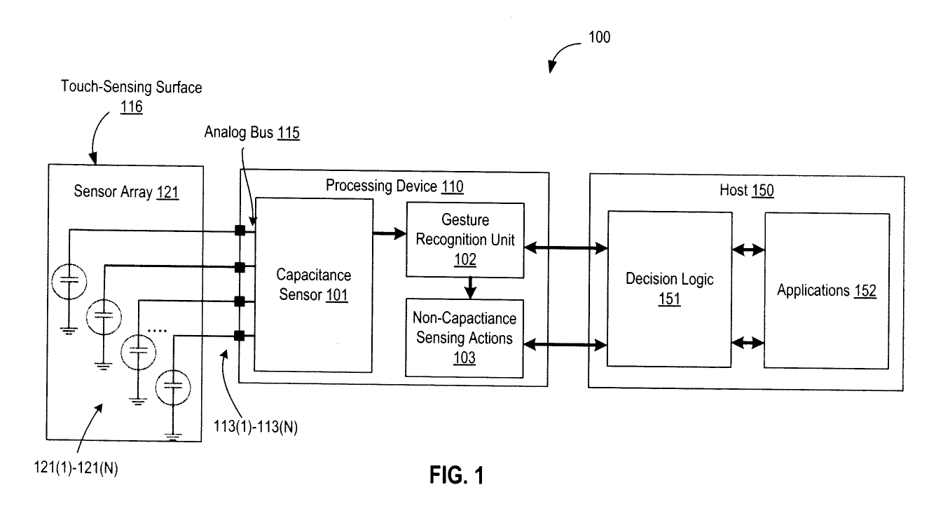

FIG. 1 illustrates a block diagram of one embodiment of an electronic device 100. The electronic device 100 includes a touch-sensing surface 116 (e.g., a touchscreen, a touch pad, etc.) coupled to a processing device 110 and a host 150. In one embodiment, the touch-sensing surface 116 is a two-dimensional user interface that uses a sensor array 121 to detect touches on the surface 116. The touch-sensing surface 116 is logically divided into multiple logical zones, with each zone having a configurable granularity.

In one embodiment, the sensor array 121 includes sensor elements 121(1)-121(N) (where N is a positive integer) that are disposed as a two-dimensional matrix (also referred to as an XY matrix). The sensor array 121 is coupled to pins 113(1)-113(N) of the processing device 110 via an analog bus 115 transporting multiple signals. In this embodiment, each sensor element 121(1)-121(N) is represented as a capacitor. The capacitance of the sensor array 121 is measured by a capacitance sensor 101 in the processing device 110.

In one embodiment, the capacitance sensor 101 may include a relaxation oscillator or other means to convert a capacitance into a measured value. The capacitance sensor 101 may also include a counter or timer to measure the oscillator output. The capacitance sensor 101 may further include software components to convert the count value (e.g., capacitance value) into a sensor element detection decision (also referred to as switch detection decision) or relative magnitude. It should be noted that there are various known methods for measuring capacitance, such as current versus voltage phase shift measurement, resistor-capacitor charge timing, capacitive bridge divider, charge transfer, successive approximation, sigma-delta modulators, charge-accumulation circuits, field effect, mutual capacitance, frequency shift, or the like. It should be noted however, instead of evaluating the raw counts relative to a threshold, the capacitance sensor 101 may be evaluating other measurements to determine the user interaction. For example, in the capacitance sensor 101 having a sigma-delta modulator, the capacitance sensor 101 is evaluating the ratio of pulse widths of the output, instead of the raw counts being over a certain threshold.

In one embodiment, the processing device 110 further includes a gesture recognition unit 102. Operations of the gesture recognition unit 102 may be implemented in firmware; alternatively, it may be implemented in hardware or software. The gesture recognition unit 102 stores parameters that define the location (e.g., XY coordinates) and granularity (e.g., a half, a quarter, ⅛, or any percentage with respect to the size of the touch-sensing surface 116) of each logical zone, and a set of rules that define the gestures to be recognized. The gesture recognition unit 102 receives signals from the capacitance sensor 101, and determines the state of the sensor array 121, such as whether a conductive object (e.g., a finger) is detected on or in proximity to the sensor array 121 (e.g., determining the presence of the conductive object), where the conductive object is detected on the sensor array (e.g., determining one or more logical zones in which the conductive object is detected), tracking the motion of the conductive object (e.g., determining a temporal sequence of logical zones in which the movement of the conductive object is detected), or the like.

In another embodiment, instead of performing the operations of the gesture recognition unit 102 in the processing device 110, the processing device 101 may send the raw data or partially-processed data to the host 150. The host 150, as illustrated in FIG. 1, may include decision logic 151 that performs some or all of the operations of the gesture recognition unit 102. Operations of the decision logic 151 may be implemented in firmware, hardware, and/or software. The host 150 may include high-level Application Programming Interface (API) in applications 152 that perform routines on the received data, such as compensating for sensitivity differences, other compensation algorithms, baseline update routines, start-up and/or initialization routines, interpolation operations, scaling operations, or the like. The operations described with respect to the gesture recognition unit 102 may be implemented in the decision logic 151, the applications 152, or in other hardware, software, and/or firmware external to the processing device 110. In some other embodiments, the processing device 110 is the host 150.

In another embodiment, the processing device 110 may also include a non-capacitance sensing actions block 103. This block 103 may be used to process and/or receive/transmit data to and from the host 150. For example, additional components may be implemented to operate with the processing device 110 along with the sensor array 121 (e.g., keyboard, keypad, mouse, trackball, LEDs, displays, or the like).

The processing device 110 may reside on a common carrier substrate such as, for example, an integrated circuit (IC) die substrate, a multi-chip module substrate, or the like. Alternatively, the components of the processing device 110 may be one or more separate integrated circuits and/or discrete components. In one embodiment, the processing device 110 may be the Programmable System on a Chip (PSoC™) processing device, developed by Cypress Semiconductor Corporation, San Jose, Calif. Alternatively, the processing device 110 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. In an alternative embodiment, for example, the processing device 110 may be a network processor having multiple processors including a core unit and multiple micro-engines. Additionally, the processing device 110 may include any combination of general-purpose processing device(s) and special-purpose processing device(s).

In one embodiment, the electronic system 100 is implemented in a device that includes the touch-sensing surface 116 as the user interface, such as handheld electronics, portable telephones, cellular telephones, notebook computers, personal computers, personal data assistants (PDAs), kiosks, keyboards, televisions, remote controls, monitors, handheld multi-media devices, handheld video players, gaming devices, control panels of a household or industrial appliances, or the like. Alternatively, the electronic system 100 may be used in other types of devices. It should be noted that the components of electronic system 100 may include all the components described above. Alternatively, electronic system 100 may include only some of the components described above, or include additional components not listed herein.

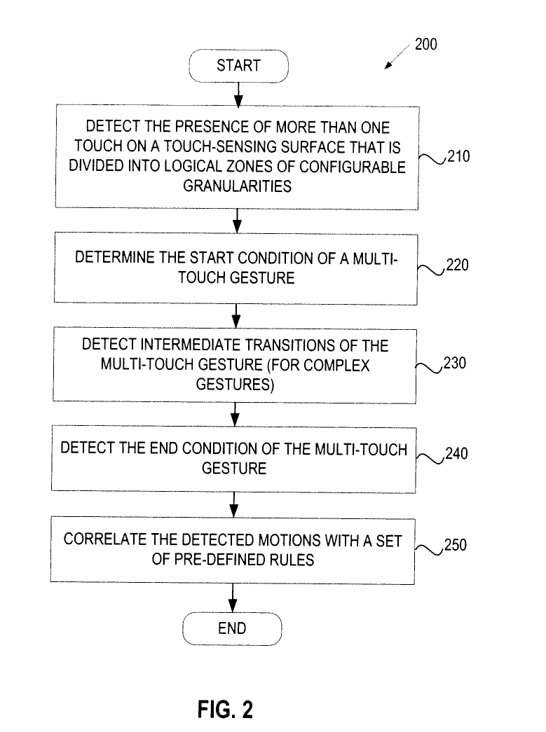

FIG. 2 illustrates a flow diagram of a method 200 for detecting the motion of multiple touches on a touch-sensing surface and to recognize a pre-defined multi-touch gesture, according to one embodiment of the present invention. The method 200 does not make use of the exact XY location of any of the touches. Instead, the method 200 determines the approximate location of the touches (e.g., which logical zones are activated by the touches), and then tracks changes in the activated zones.

The method 200 may be performed by the electronic system 100 of FIG. 1 that may comprise hardware (e.g., circuitry, dedicated logic, programmable logic, microcode, etc.), firmware (e.g., instructions or data which are permanently or semi-permanently embedded in circuitry), software (e.g., instructions run on a processing device to perform hardware simulation), or a combination thereof. In one embodiment, the method 200 is performed by the gesture recognition unit 102 using the touch-sensing surface 116 as a user interface. In the following description, it is assumed that a “touch” is caused by pressing a finger on the touch-sensing surface 116. However, it is understood that a touch may be caused by other conductive objects that is capable of forming a contact with the surface 116.

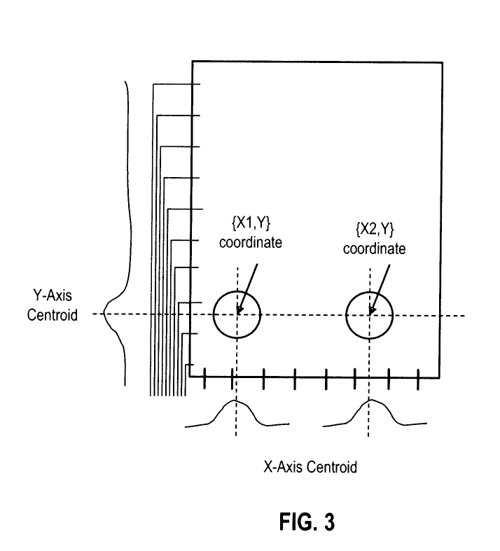

At block 210, the gesture recognition unit 102 detects the presence of multiple substantially simultaneous touches on the touch-sensing surface 116. According to embodiments of the present invention, the gesture recognition unit 102 checks individual row and column sensor activation status to identify touch conditions that can only be caused by the presence of more than one finger. The gesture recognition unit 102 is customized to match the physical construction of the touch-sensing surface 116. In an embodiment where the touch-sensing surface 116 is implemented an XY matrix, the presence of multiple touches entails the presence of more than one maximum on at least one of the X and Y sensing axes. FIG. 3 illustrates an example of detecting the presence of two maxima on the X sensing axis of an XY matrix touchscreen. It is noted that the detection of more than one touch is not based on the activation of multiple logical zones, as it is likely that a single finger may activate multiple zones at the same time when the finger transitions from one zone to another.

Once the presence of more than one touch is detected, at block 220, the gesture recognition unit 102 captures a start condition of a multi-touch gesture. The start condition is defined as a combination of logical zones activated by the detected touch. The start condition is a key factor in differentiating one gesture from another when the motion of multiple gestures is similar, or similar in part.

Proceeding to block 230, the gesture recognition unit 102 detects intermediate transitions of the multi-touch gesture. Simple gestures can be defined as having a start condition (captured at block 220) and an end condition (captured at block 240), without any intermediate transitions. More complex gestures may be defined to have one or more intermediate conditions, through which a user's gesture needs to transition in a pre-defined sequence.

Proceeding to block 240, the gesture recognition unit 102 detects the end condition of the multi-touch gesture. The end condition is defined by the logical zones activated by the detected touches when a gesture reaches an end (e.g., when one of the touches is released or when the touches are timed out). Once the touches transition to a pre-defined end condition, the gesture can be declared as recognized.

Proceeding to block 250, the gesture recognition unit 102 correlates the captured start condition, intermediate condition and end condition with pre-defined rules to determine which gesture has occurred. The correlation may be performed by a parser that starts at the start condition and performs a table search for the captured sequence of conditions. In alternative embodiment, the correlation may be performed as inline processing where a table of valid condition sequences is followed as each condition is captured. Such a table of conditions will have multiple entry and exit points, and may be implemented as a linked list of transition states, separate linear tables for each gesture, or other combination.

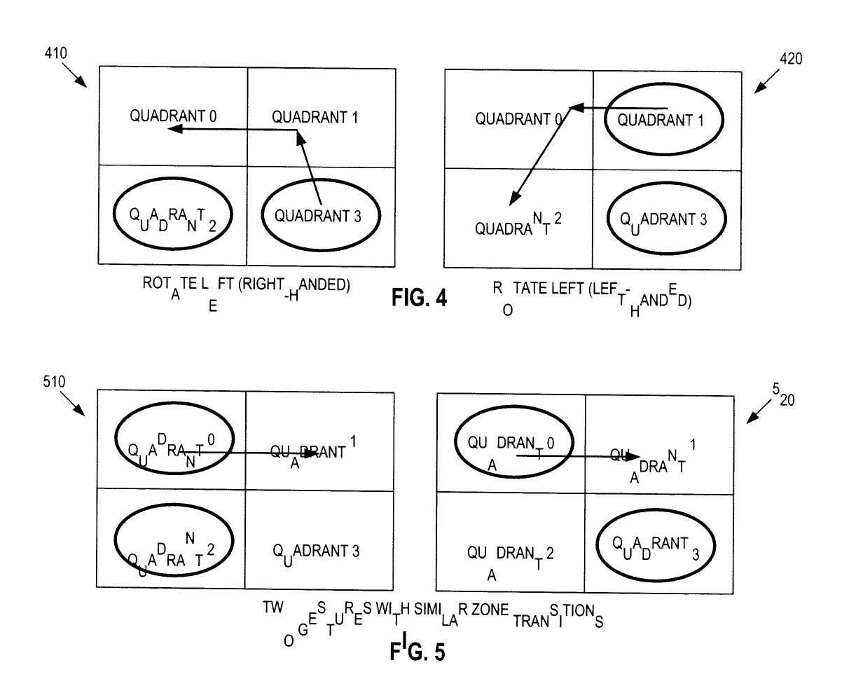

Additional features of the method 200 are described in greater detail below with reference to FIGS. 4-7. In the following description, the term “touchscreen” is used to represent one embodiment of the touch-sensing surface 116. It is understood that the method 200 is not limited to a touchscreen and can be applied to any two-dimensional touch-sensing surface.

One feature of the method 200 is that it supports multiple input methods for the same gesture. That is, different sets of rules can be defined for different sequences of events that constitute the same gesture. This feature allows two or more finger motion sequences to be defined for the same gesture. Thus, a different set of rule for the same gesture can be defined for left-handers, right-handers, single-handed use (e.g., the use of the thumb and/or the index finger), or two-handed use (e.g., the use of two thumbs).

FIG. 4 shows an example of two definitions of a “rotate left” gesture. In FIG. 4, the circles represent finger locations at the start of the gesture and the arrow indicates the motion of one of the fingers to activate the gesture. The gesture shown on the left (a gesture 410) is better suited to right-handers, keeping the thumb stationary in the lower left corner of the touchscreen while the index finger draws a quarter circle in a counter clockwise direction. The gesture on the right (a gesture 420) shows the left hander's version, keeping the thumb stationary in the lower right hand corner of the touchscreen while the index finger draws a quarter circle in the counter clockwise direction.

Another feature of the method 200 is that it resolves gesture aliasing. Gesture aliasing is caused by gestures that have similar finger motions. A key to offering a compelling gesture-based multi-touch user input system is to define simple (and therefore intuitive) gestures to implement the desired features of the user interface. This simplicity creates a challenge for the detection method, as the zone transitions of simple gestures may be so similar to each other that incorrect detection could occur. The method 200 provides a number of mechanisms for reliable gesture recognition. The mechanisms include capturing the start condition, gesture-on-release, and gesture timeout.

FIG. 5 illustrates an example of two gestures 510 and 520 that are defined with the same transition logic, which is movement of one finger from left to right. However, gestures 510 and 520 have different start conditions. Gesture 510 is defined as having a start condition with Quadrant 0 (Q0) and Quadrant 2 (Q2) activated. Gesture 520 is defined as having a start condition with Q0 and Quadrant 3 (Q3) activated. The difference in the activated zones can be used to differentiate the two gestures. Thus, capturing the start condition provides a mechanism for accurately determining which gesture is being activated.

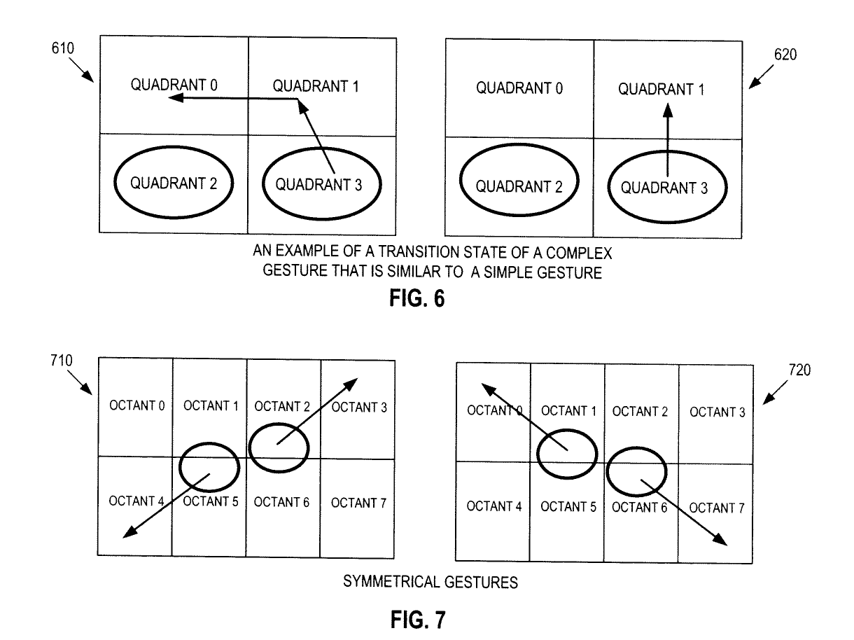

FIG. 6 shows a more complex case where two gestures 610 and 620 are defined to have the same start condition and similar movements. Gesture 610 is a more complex gesture that has an intermediate finger transition from Q3 to Q1, followed by movement from Q1 to Q0. Gesture 620 is a simpler gesture that has one finger movement from Q3 to Q1. Since the start condition is the same for both gestures 610 and 620, it is not clear which gesture is being activated when the user moves his right finger from Q3 to Q1. Some conventional techniques may incorrectly recognize gesture 610 as the completion of a simpler gesture (gesture 620).

The method 200 provides two mechanisms to distinguish similar gestures that have the same start condition. A first mechanism is called “gesture-on-release.” Using the example of FIG. 6, if the user moves his fingers from Q3 to Q1, and then removes one of his fingers when Q1 is reached, the gesture on the right (gesture 620) is deemed activated.

A second mechanism is called “gesture timeout.” Referring again to FIG. 6, if the user moves his right finger from Q3 to Q1, and keeps the finger on Q1 for a pre-determined amount of time without transitioning to Q0, the gesture shown on the right (gesture 620) is deemed activated.

A further feature of the method 200 is “back-to-back gesturing.” A user may sometimes wish to activate gestures rapidly back-to-back. Typical examples might be multiple rotate-by-90 degrees or multiple zoom-in/zoom-out gestures for image manipulation. The method 200 accommodates this back-to-back gesturing by allowing the user to keep one finger on the touchscreen at all times, while the second finger can be removed from the end condition of the first gesture and re-positioned back to the start condition of the back-to-back gesture. This back-to-back gesturing is far less cumbersome than removing both fingers and starting over.

The method 200 is also designed to prevent accidental back-to-back gesturing. Accidental back-to-back gesturing may occur if the user completes a gesture, but continues to move one or more of his fingers. The method 200 provides protection against accidental back-to-back gesturing by detecting the end condition of a gesture and capturing the start condition of a subsequent gesture. With the method 200, once a gesture has been activated, a new gesture may not be activated until at least one finger is removed from the touchscreen.

An additional feature of the method 200 is that it detects and recognizes multi-touch gestures on standard 2-layer XY matrix touchscreens as well as split-screen 2-layer XY matrix touchscreens. While the method 200 can support both touchscreen constructions, the split-screen construction generally offers superior gesture recognition capability since the split-screen construction greatly reduces ghosting or aliasing limitations caused by the physical symmetry of the standard 2-layer XY matrix touchscreens.

To implement the method 200 on a standard 2-layer XY matrix touchscreen, most gestures may need to be defined carefully for potential incorrect detection. For some gestures, however, the physical symmetry of a standard 2-layer XY matrix touchscreen may simplify the detection logic of the gesture recognition. An example of gestures 710 and 720 is shown in FIG. 7, which illustrates two possible activations of the same gesture. The gesture 710 on the left may be more natural for a right-handed user, while the gesture 720 on the right may be more natural for a left-hander. In the case of a split-screen construction touchscreen, the gestures 710 and 720 would need to be defined and recognized independently, and then mapped to the same operation (e.g., zoom-out operations). For standard 2-layer XY matrix touchscreens, due to the physical symmetry of the touchscreen construction, the gestures 710 and 720 will appear identical to the gesture recognition unit 102.

FIGS. 8-16 illustrates some examples of gestures and the corresponding gesture recognition rules. In the following description, “Q” refers to “quadrant” (a quarter of the touchscreen) and “O” refers to “octant” (⅛ of the touchscreen). FIG. 8 illustrates an example of linear control gestures and the corresponding recognition rules. The linear control increment/decrement gesture recognition rules may be defined as:
LINEAR CONTROL INCREMENT
START CONDITION=Q2 and Q3 zones active
   INTERMEDIATE CONDITION=O6→O7 transition
   END CONDITION=Q2 and Q3 zones active
LINEAR CONTROL DECREMENT
   START CONDITION=Q2 and Q3 zones active
   INTERMEDIATE CONDITION=O7→O6 transition
   END CONDITION=Q2 and Q3 zones active

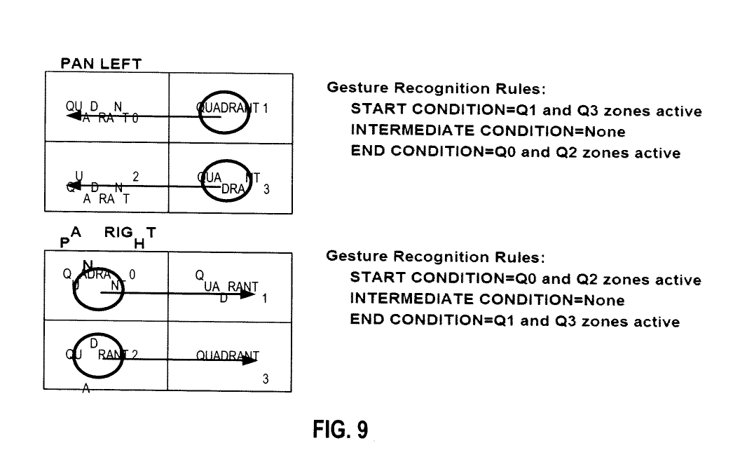

FIG. 9 illustrates an example of pan left/right gestures and the corresponding recognition rules. The pan left/right gesture recognition rules may be defined as:
PAN LEFT
   START CONDITION=Q1 and Q3 zones active
   INTERMEDIATE CONDITION=None
   END CONDITION=Q0 and Q2 zones active
PAN RIGHT
   START CONDITION=Q0 and Q2 zones active
   INTERMEDIATE CONDITION=None
   END CONDITION=Q1 and Q3 zones active

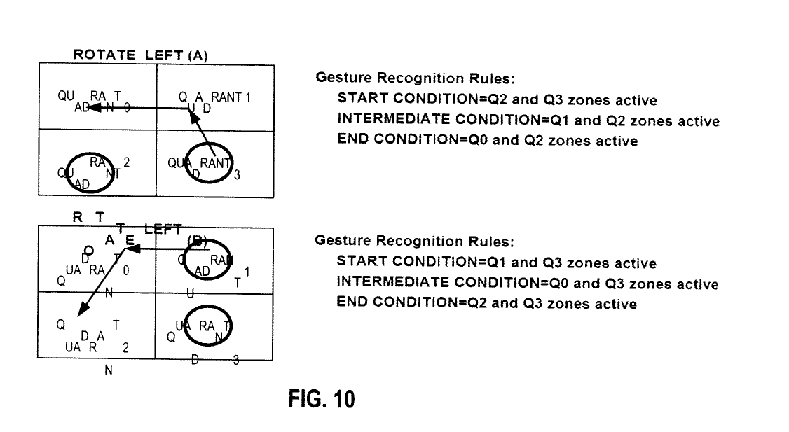

FIG. 10 illustrates an example of two rotate left gestures (e.g., for right-hander and left-hander) and the corresponding recognition rules. The rotate left gesture recognition rules may be defined as:
ROTATE LEFT (A)
   START CONDITION=Q2 and Q3 zones active
   INTERMEDIATE CONDITION=Q1 and Q2 zones active
   END CONDITION=Q0 and Q2 zones active
ROTATE LEFT (B)
   START CONDITION=Q1 and Q3 zones active
INTERMEDIATE CONDITION=Q0 and Q3 zones active
   END CONDITION=Q2 and Q3 zones active

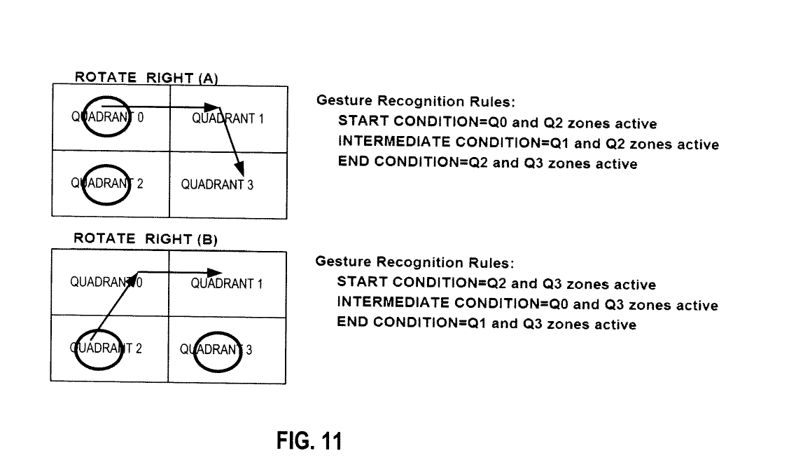

FIG. 11 illustrates an example of two rotate right gestures (e.g., for right-hander and left-hander) and the corresponding recognition rules. The rotate right gesture recognition rules may be defined as:
ROTATE RIGHT (A)
   START CONDITION=Q0 and Q2 zones active
   INTERMEDIATE CONDITION=Q1 and Q2 zones active
   END CONDITION=Q2 and Q3 zones active
ROTATE RIGHT (B)
   START CONDITION=Q2 and Q3 zones active
   INTERMEDIATE CONDITION=Q0 and Q3 zones active
   END CONDITION=Q1 and Q3 zones active

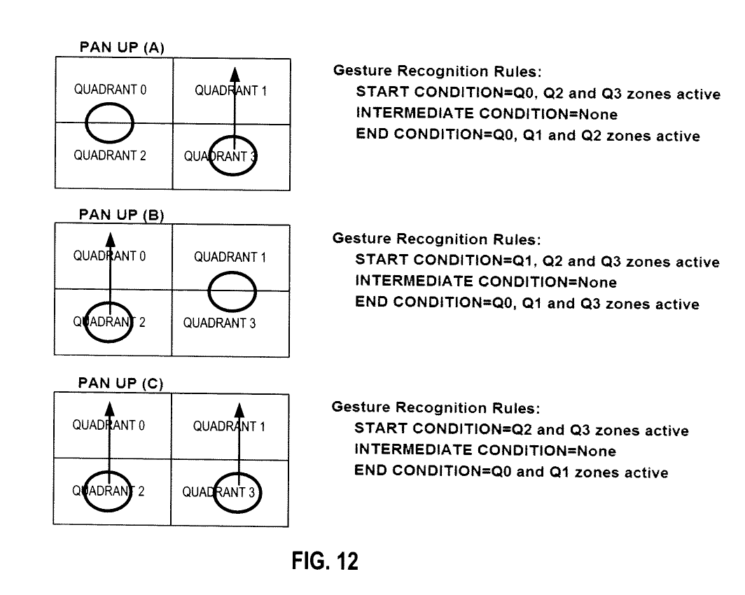

FIG. 12 illustrates an example of three pan-up gestures and the corresponding recognition rules. The pan-up gesture recognition rules may be defined as:
PAN UP (A)
   START CONDITION=Q0, Q2 and Q3 zones active
   INTERMEDIATE CONDITION=None
   END CONDITION=Q0, Q1 and Q2 zones active
PAN UP (B)
   START CONDITION=Q1, Q2 and Q3 zones active
   INTERMEDIATE CONDITION=None
   END CONDITION=Q0, Q1 and Q3 zones active
PAN UP (C)
   START CONDITION=Q2 and Q3 zones active
   INTERMEDIATE CONDITION=None
   END CONDITION=Q0 and Q1 zones active

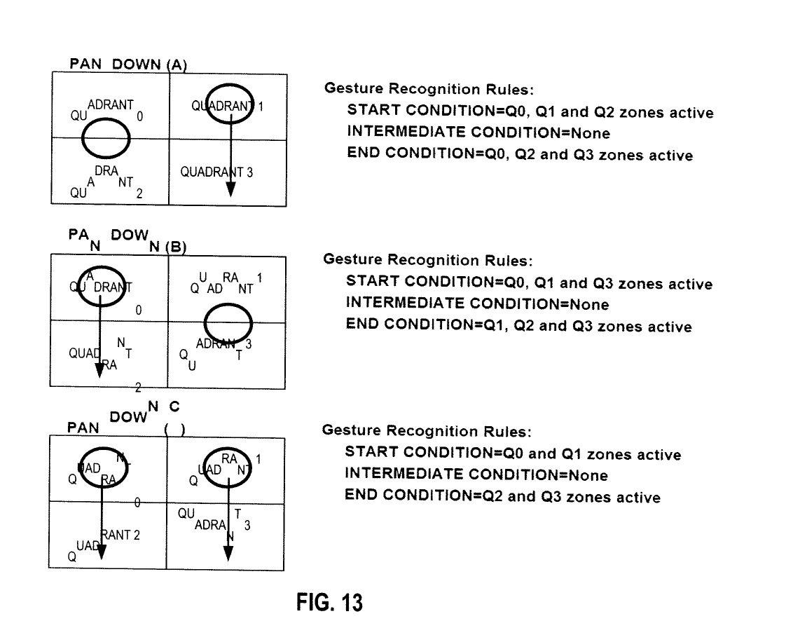

FIG. 13 illustrates an example of three pan-down gestures and the corresponding recognition rules. The pan-down gesture recognition rules may be defined as:
PAN DOWN (A)
   START CONDITION=Q0, Q1 and Q2 zones active
   INTERMEDIATE CONDITION=None
   END CONDITION=Q0, Q2 and Q3 zones active
PAN DOWN (B)
   START CONDITION=Q0, Q1 and Q3 zones active
   INTERMEDIATE CONDITION=None
   END CONDITION=Q1, Q2 and Q3 zones active
PAN DOWN (C)
   START CONDITION=Q0 and Q1 zones active
   INTERMEDIATE CONDITION=None
   END CONDITION=Q2 and Q3 zones active

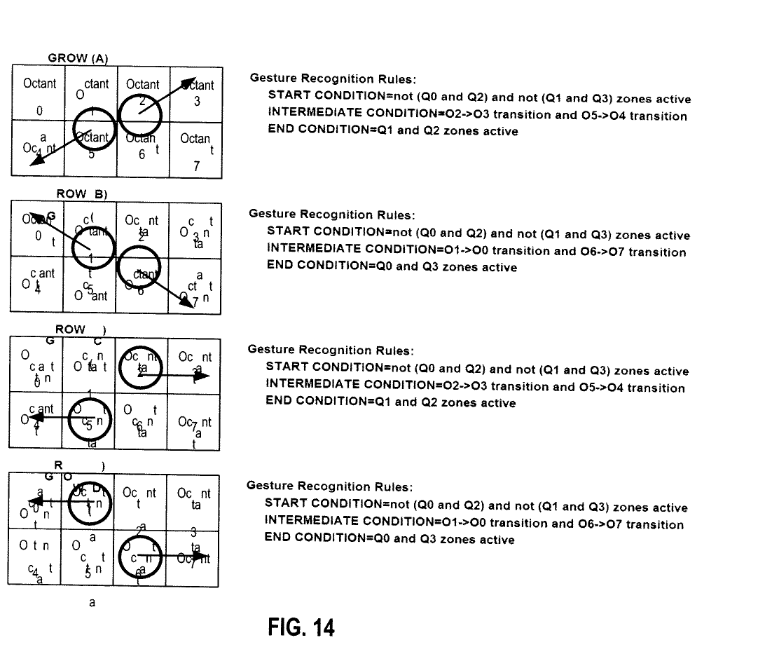

FIG. 14 illustrates an example of four grow (zoom in) gestures and the corresponding recognition rules. The grow gesture recognition rules may be defined as:
GROW (A)
   START CONDITION=not (Q0 and Q2) and not (Q1 and Q3) zones active
   INTERMEDIATE CONDITION=O2→O3 transition and O5→O4 transition
   END CONDITION=Q1 and Q2 zones active
GROW (B)
   START CONDITION=not (Q0 and Q2) and not (Q1 and Q3) zones active
   INTERMEDIATE CONDITION=O0→O0 transition and O6→O7 transition
   END CONDITION=Q0 and Q3 zones active
GROW (C)
   START CONDITION=not (Q0 and Q2) and not (Q1 and Q3) zones active
   INTERMEDIATE CONDITION=O2→O3 transition and O5→O4 transition
   END CONDITION=Q1 and Q2 zones active
GROW (D)
   START CONDITION=not (Q0 and Q2) and not (Q1 and Q3) zones active
   INTERMEDIATE CONDITION=O1→O0 transition and O6→O7 transition
   END CONDITION=Q0 and Q3 zones active

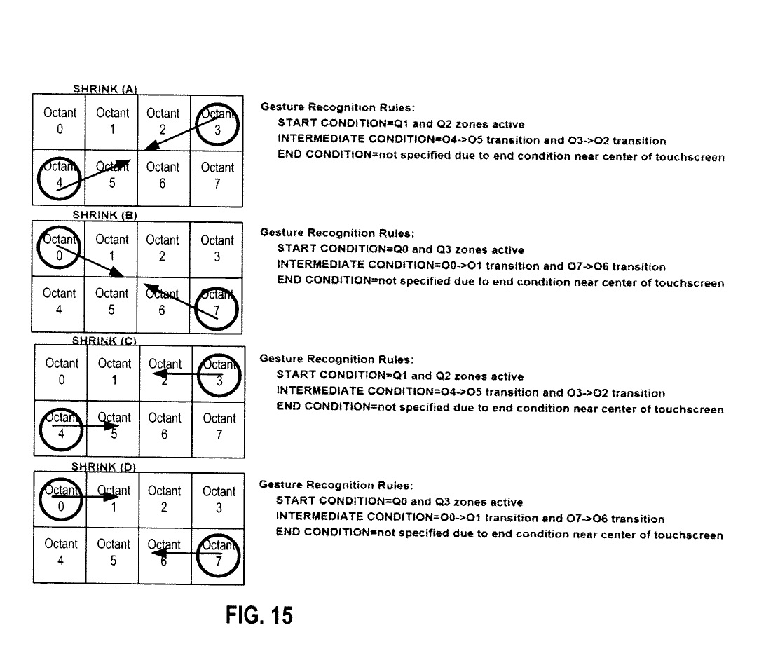

FIG. 15 illustrates an example of four shrink (zoom out) gestures and the corresponding recognition rules. The shrink gesture recognition rules may be defined as:
SHRINK (A)
   START CONDITION=Q1 and Q2 zones active
   INTERMEDIATE CONDITION=O4→O5 transition and O3→O2 transition
   END CONDITION=not specified due to end condition near center of touchscreen
SHRINK (B)
   START CONDITION=Q0 and Q3 zones active
   INTERMEDIATE CONDITION=O0→O1 transition and O7→O6 transition
   END CONDITION=not specified due to end condition near center of touchscreen
SHRINK (C)
   START CONDITION=Q1 and Q2 zones active
   INTERMEDIATE CONDITION=O4→O5 transition and O3→O2 transition
   END CONDITION=not specified due to end condition near center of touchscreen
SHRINK (D)
   START CONDITION=Q0 and Q3 zones active
   INTERMEDIATE CONDITION=O0→O1 transition and O7→O6 transition
   END CONDITION=not specified due to end condition near center of touchscreen

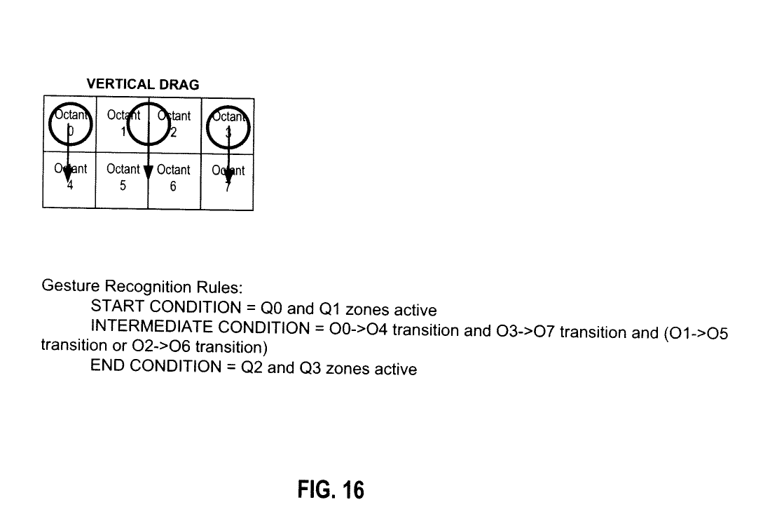

FIG. 16 illustrates an example of a 3-finger vertical drag gesture and the corresponding recognition rules. It is noted that this gesture may need to be recognized using zones that are smaller than octants (e.g., 1/16th the size of the touchscreen) to guarantee reliable detection. The granularity of the zones may be dependent on the size of the user's fingers relative to the physical size of the octants. The 3-finger vertical drag gesture recognition rules may be defined as:
START CONDITION=Q0 and Q1 zones active
INTERMEDIATE CONDITION=O0→O4 transition and
   O3→O7 transition and
   O1→O5 transition or O2→O6 transition)
END CONDITION=Q2 and Q3 zones active

The gesture recognition rules, as interpreted by the system software, firmware, or other state machine, are order dependent and may contain other intermediate states that are not recognized by the system. For example, in the left/right panning gestures in FIG. 9 or the vertical drag of FIG. 16, the sensed touches may not transition into the adjacent zones at the same instant in time. The system filters out these intermediate combinations until all fingers transition to the pre-defined end condition.

It is also noted that the assigned actions for the referenced gestures may be mapped to other functions. The specific mapping listed here is merely for example purposes. Any gestures that make logical sense to the user can be defined by rules and recognized. However, the complexity of the software, firmware, or state machine that recognizes these gestures generally increases with the number of gestures that need to be recognized.

Embodiments of the present invention, described herein, include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions. The computer-readable transmission medium includes, but is not limited to, electrical, optical, acoustical, or other form of propagated signal (e.g., carrier waves, infrared signals, digital signals, or the like), or another type of medium suitable for transmitting electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
detecting a plurality of substantially simultaneous touches on a touch-sensing surface that is divided into a plurality of logical zones, each of the logical zones having a configurable granularity; and
tracking motions of the touches across the logical zones to identify a multi-touch gesture.

2. The method of claim 1, wherein tracking motions further comprises:
correlating the motions to a set of rules defining the multi-touch gesture.

3. The method of claim 1, wherein tracking motions further comprises:
detecting a temporal sequence of the logic zones that are activated by the touches.

4. The method of claim 1, wherein tracking motions further comprises:
capturing a start condition of the multi-touch gesture, the start condition defined by a first set of the logical zones activated by the touches; and
detecting an end condition of the multi-touch gesture, the end condition defined by a second set of the logical zones activated by the touches.

5. The method of claim 1, wherein tracking motions further comprises:
determining an end of the multi-touch gesture by detecting a release of one of the touches.

6. The method of claim 1, wherein tracking motions further comprises:
determining an end of the multi-touch gesture by detecting that the touches remain in the same logical zones for a pre-determined period of time.

7. The method of claim 1, wherein tracking motions further comprises:
detecting back-to-back gesturing by detecting at least one of the touches remaining on the touch-sensing surface and at least one of other touches being released.

8. The method of claim 1, wherein detecting a plurality of substantially simultaneous touches further comprising:
for each of the touches, determining one of the logical zones activated by the touch without determining an exact location of the touch.

9. The method of claim 1, further comprising:
detecting the touches generated by one or more of the following operations: a left-hand operation, a right-hand operation, a single-hand operation, and a dual-hand operation.

10. The method of claim 1, wherein the touch-sensing surface is formed by a two-dimensional sensor array and recognition rules for the multi-touch gesture are customized in view of a construction of the two-dimensional sensor array.

11. An apparatus comprising:
a touch-sensing surface to detect a plurality of substantially simultaneous touches, the touch-sensing surface divided into a plurality of logical zones; and
a gesture recognition unit, which receives input from the touch-sensing surface to track motions of the touches across the logical zones for gesture identification, and is configurable to store parameters that define a granularity of each of the logical zones in view of a multi-touch gesture to be identified.

12. The apparatus of claim 11, wherein the gesture recognition unit is configurable to store rules defining the multi-touch gesture and correlate the motions to the rules.

13. The apparatus of claim 11, wherein the gesture recognition unit is configurable to detect a temporal sequence of the logic zones that are activated by the touches.

14. The apparatus of claim 11, wherein the gesture recognition unit is further configurable to capture a start condition of the multi-touch gesture and to detect an end condition of the multi-touch gesture, the start condition defined by a first set of the logical zones activated by the touches and the end condition defined by a second set of the logical zones activated by the touches.

15. The apparatus of claim 11, wherein the gesture recognition unit is further configurable to detect the touches generated by one or more of the following operations: a left-hand operation, a right-hand operation, a single-hand operation, and a dual-hand operation

16. The apparatus of claim 11, wherein the touch-sensing surface is formed by a two-dimensional sensor array and recognition rules for the multi-touch gesture are customized in view of a construction of the two-dimensional sensor array.

17. The apparatus of claim 11, wherein the touch-sensing surface is a matrix capacitive-sensing surface.

18. A computer readable medium including instructions that, when executed by a processing system, cause the processing system to perform a method, the method comprising:
detecting a plurality of substantially simultaneous touches on a touch-sensing surface that is divided into a plurality of logical zones, each of the logical zones having a configurable granularity; and
tracking motions of the touches across the logical zones to identify a multi-touch gesture.

19. The computer readable medium of claim 18, wherein tracking motions further comprises:
correlating the motions to a set of rules defining the multi-touch gesture.

20. The computer readable medium of claim 18, wherein tracking motions further comprises:
capturing a start condition of the multi-touch gesture, the start condition defined by a first set of the logical zones activated by the touches; and
detecting an end condition of the multi-touch gesture, the end condition defined by a second set of the logical zones activated by the touches.
